(19) United States
(12) Patent Application Publication
(10) Pub. No.: US 2014/0297402 A1
(43) Pub. Date: Oct. 2, 2014

(54) Methods and Systems for Promoting and Tracking Digital Offers across Multiple Devices

(71) Applicant: Media Group LTD., Tel Aviv (IL)

(72) Inventor: Ariel SOUDAK, Tel Aviv (IL)

(21) Appl. No.: 14/243,092

(22) Filed: Apr. 2, 2014

Related U.S. Application Data
(60) Provisional application No. 61/807,389, filed on Apr. 2, 2013.
(60) Provisional application No. 61/858,366, filed on Jul. 25, 2013.

(51) Int. Cl. G06Q 30/02

(52) U.S. Cl. CPC G06Q 30/0246
USPC 705/14.45

(57) ABSTRACT

The present invention provides a method for promoting and tracking digital offers, initiated and displayed on one device, intended for use on another device. The method comprises the steps of: promoting plurality of digital offers through data communication network, providing a user with an interface for browsing data communication network while using a first device to select one digital offer and initiate transmission of an offer message including a hyperlink to the digital offer by providing unique communication identifier, associating between the selected digital offer and the transmitted message, transmitting the offer message with hyperlink of the digital offer to the second device, using the user provided unique communication identifier and receiving feedback message of the user activation or usage of the digital offer at a second device from an application program of the second device with the association to the selected digital offer.

### TECHNICAL FIELD

The present invention relates to the field of promoting and tracking digital offers, initiated/displayed on one device, intended for use on another device.

### BACKGROUND

International patent application No. WO2014007854 discloses a method for providing message-enabled advertisements and content delivery, including SMS-enabled advertisements and content delivery. According to this method, a user is provided with an interface including a text entry field for initiating a request for sending a message with advertised content to a second device associated with a phone number entered through the text entry field. This application fails to provide a tracking solution between the advertisement promoted on one device and the consumption of the content, such as a mobile application, on another device.

### SUMMARY OF INVENTION

A method for tracking a digital offer which is promoted on a first computer device to be utilized on a second computer device. The method comprises the steps of:
Promoting a number of digital offers through data communication network, exposed to a user selection on a first computer device (i.e. personal computer),
Providing a user with an interface for browsing data communication network while using a first device - to select one digital offer and initiate transmission of a message related to the selected offer, including a hyperlink to the digital offer, by providing unique communication identifier (i.e. mobile phone number or an email address) which is available through communication service on the user's second device,
Associating between the selected digital offer and the transmitted message and the user,
Transmitting the offer message with hyperlink of the selected digital offer to the second computer device, using the user provided unique communication identifier, and receiving feedback message of the user's activation or usage of the digital offer on a second device from an application running on the second device, with the association to the selected digital offer.

According to some embodiments of the present invention, each digital offer is assigned with a unique ID identifying both the digital offer and the user. The unique ID is embedded within the offer message transmitted to the second device and in the feedback message is sent back from the second device.

According to some embodiments of the present invention, the feedback message is reported to the publisher of the digital offer with the association between the activation of digital offer on the second device and promotion of the digital offer in the first computer device.

According to some embodiments of the present invention, promotion of the digital offer is placed in a web page as part of a content portal operated by a publisher.

According to some embodiments of the present invention, promotion of the digital offer is placed as a banner in a web page.

According to some embodiments of the present invention, promotion of the digital offer is placed in advertising on a webpage which is a result of a search query performed in a browsing application, wherein the digital offer is associated with keywords of the search query and activation of the digital offer in the second computer device.

According to some embodiments of the present invention, a feedback message is sent to the offer manager with the association between the search keywords that initiated the promotion of the digital offer on the first device, the digital offer promoted on the first device and activation of the digital offer on the second device.

The present invention provides a method for tracking a digital offer to be utilized on a mobile device. The method comprises the steps of:
Creating a promotional digital offer page within content media source available through a data communication network,
Identifying a user surfing through the media source using user's computing device and directing the user to at least one offer page, enabling the user to insert user's mobile phone number or email address within the offer page using one computing device, sending an electronic message to a designated mobile phone associated with the inserted number, or the end user's email address, wherein the sent message includes a hyperlink to activation of the selected digital offer and a unique ID identifying the digital offer and the user, Activating or Consuming the digital offer once the user opens the SMS or email message on her or his second device and clicks the embedded hyperlink, sending indication of digital offer activation with the unique ID associated with the selected digital offer, content media source & the user.

The present invention provides a system for tracking a digital offer to be utilized on a mobile phone connected to cellular communication network. The system is comprised of:
Publishing platform for promoting a number of digital offers through data communication network, exposed to user selection on a first device,
Offers Manager server which enables a user browsing through data communication network to select one digital offer, provide unique communication identifier which is available through communication service on another device of the same user, initiating transmission of an offer message including a hyperlink to the selected digital offer by providing communication address which is available through messaging service on the user mobile device, associating between the selected digital offer and the transmitted message, receiving offer activation notification from an application running on the second device, and sending a feedback message about the user activation of the selected digital offer with the association to the selected digital offer.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of a system and environment components which are involved in a digital offer promotion and a re-direction process, according to some embodiments of the invention;

FIG. 1A is a block diagram of a system and environment components which are involved in a promotion and a re-direction process of mobile application installation, according to some embodiments of the invention;

FIG. 2 is a flowchart illustrating a method of promoting and redirecting digital offer, according to some embodiments of the invention;

FIG. 2A is a flowchart illustrating a method of promoting and redirecting installation of a mobile application utilizing search engine platform, according to some embodiments of the invention;

FIG. 2B is a flowchart illustrating a method of promoting and redirecting installation of mobile application utilizing search engine platform, according to some embodiments of the invention

FIG. 3 is a sequence diagram illustrating a technical processing of a digital offer, according to some embodiments of the invention;

FIG. 3A is a sequence diagram illustrating a technical processing of promoting and redirecting installation of mobile application utilizing search engine platform, according to some embodiments of the invention.

FIG. 4 is an information flow between different entities related to web publishing platform, according to some embodiments of the invention;

FIG. 4A a illustrates an information flow between different entities related to search engine platform, according to some embodiments of the invention;

FIG. 5 illustrates a general work flow of promoting digital offers according to some embodiments of the invention;

FIG. 6 illustrates a work flow of a first scenario of promoting digital offers, according to some embodiments of the invention;

FIG. 7 illustrates a simple presentation of an offer wall within a browser window;

FIG. 8 illustrates a simple presentation of an offer wall within a publisher site while being reviewed through a browser, according to some embodiments of the invention.

FIG. 9 is a screen shot example illustrating promotion of a mobile application in search result web page, according to some embodiments of the invention; and

FIG. 10 is a screen shot illustrating the usage of the promotion of a mobile application in search result web page on a device with lower screen resolution, such as a mobile device, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “digital offer” or “offer” as used herein in this application, is defined as a digital service that can be consumed on a computational device, such as content service for mobile phones (e.g. such as weather updates, sport results, news etc.) or an application for a mobile phone.

The term “Offer-Wall” as used herein in this application, is defined as a container of one or more advertisers' digital offers. The container may be implemented as a web page that can be hosted in many locations, it is adjustable and customizable by the publisher to fit the publisher's platform look and feel.

The term “Advertiser” or “content provider” as used herein in this application is defined as an owner of the offer and the organization that wishes to promote it to end users via various media sources.

The terms “Media source” or “publisher” or “affiliate” or “media channel” as used herein in this application, are defined as: the entity that hosts the offer wall and therefore helps promoting a digital offer. This entity may be in the form of: a web site hosting a banner, a toolbar hosting a widget, desktop widget, web widget or an installer application, i.e. entities in all forms that are able to show an offer wall as part of their function and expose it to end users.

The term “user” or “end user” as used herein in this application, is defined as a person that is surfing the web and encountering a promotion to visit the offer-wall or encounters it as part of an action she or he performs in a hosting media source.

The term “device” or “computerized device” or “computation device” as used herein in this application, is defined as any device incorporating means of computation, such as: personal computers, laptops, tablets etc.

The term “mobile device” as used herein in this application, is defined as any device which has access to cellular networks, such as: a smart phone device or a tablet which are enabled to communicate with cellular network.

The term “unique communication identifier” as used herein in this application, is defined as any identifier that may be used to communicate through a respective communication technology with an end user, i.e. mobile phone number and cellular data communication, email address and email protocols.

The present invention enables to track user consuming a digital offer promoted at a first device and activated on a second device, and provide the publisher of the digital offer with associated information of digital offer utilization in relation to the promotion of the digital offer and the relevant keywords.

The Offers which are presented to the users when surfing a data communication network using a computerized device, are targeted or be utilized on a mobile device having access to cellular network.

The process of promoting and directing a user to consume an offer begins with a user interaction within any variety of media sources that are available on a data communication network. The process begins once the user enters a promotion channel, such as a web page hosting the offer wall, or installer which hosts the offer wall tag.

The user may be exposed to a plurality of digital offers which are presented in an offer-wall when surfing with her or his device, enabling her or him to select one or more of the offers and provide her or him with an easy direction referral to the digital services or application on her or his mobile device.

These promotional methods may require usage of known advertising targeting and profiling of users, as implemented when users surf the Web. User related data and the information regarding the specific media source from which she or he navigated to the offer wall, is being sent to a server. The server includes modules for managing all users' profiles, digital offers and matches the most suitable one for each user exposure.

The advertisers, which are the digital offer owners, can create advertising campaigns in the system. Each campaign contains targeting information about their desired audience profiling. The campaign allows to define targeting filters including at least one of: regional settings, user preferences, age, gender and any other profiling parameters.

A match making algorithm is employed to select the likeliest offers to attract user attention based on one or more of the following: gathered user's surfing information, offers campaign targeting criteria, user's historic activity, analysis of similar traffic and/or characteristics of the current user request. This algorithm first filters only relevant offers to the users and ranks them according to several parameters in order to select the best ones which will appear at the offer wall.

Once the digital offers were chosen by the server, they are compiled into an offer wall, to be hosted in a relevant media source. The user is enabled to select one or more offers which appear on the offer wall and the user is also enabled to perform a request to receive direction referral, to the respective digital offer on her or his mobile device.

In order to receive a direction referral to the respective digital offer, the user is required at some point to enter her or his unique communication identifier and validate the country in which she or he is enabled to receive services. Once the user has entered her or his phone number or email and sent her or his request to the server (offer message), an SMS or an email is compiled by the server and sent to the user's device. In case of mobile phone number the SMS is sent to his mobile device. In case of an email address an email is sent to end user's email box. Each promoted digital offer is assigned with a unique ID identifying the digital offer, the publisher and the user. This unique ID is embedded in the sent message for associating the consumption on the second device of a digital offer promoted at the first device, and the search keywords for promoting the digital offer.

The SMS message is sent via an SMS communication service, optionally using a third party SMS provider service.

The user opens the SMS or email on her or his second device, containing a link to a landing page that is relevant to her or his selected digital offer. If the user clicks on the link, she or he is routed to the landing page via a server. Before opening the landing page, the server verifies and ascertains that the receiving device matches the selected offer technical requirements (for example, for a game to be played on the user device, the game has to be able to run on the device current operating system version). Based on verification results, the server determines if to present the user with the selected offer landing page or an alternate page which may contain alternative offers which may match the technical capabilities of the mobile device or an error message etc.

At the next stage the user is directed to the offer landing page or app store where the user may be asked to confirm her or his request. This step may be required for validation or authentication procedures to ascertain compliance with certain regulations, such as when purchasing an application. The user is presented with the offer details and is being asked to confirm her or his request. Once the user presses the confirm button, the user's confirmation is sent to the server again. On the server's side, the user and the user's request are documented and then the user's device can be routed to the offer.

When the user arrives to the content of the provider digital offer, the user can start consuming the content. If it's a mobile app, the user can install and open it. If it's a content service, the user can review its content. If the digital offer is enabled to send confirmation (feedback message) back to the server, such confirmation will be sent directly from the advertiser or content provider associating the promoted digital offer to the consumed content and search keywords used for promoting the digital offer, by embedding the a unique ID identifying the digital offer the publisher and the user. When there is no such option, the confirmation needs to be sent via a third party service which the offer provider can embed in the provider's technology and utilize it to send the confirmation to the server. Once confirmation is sent from the offer provider to the promoter server, the user's transaction is completed.

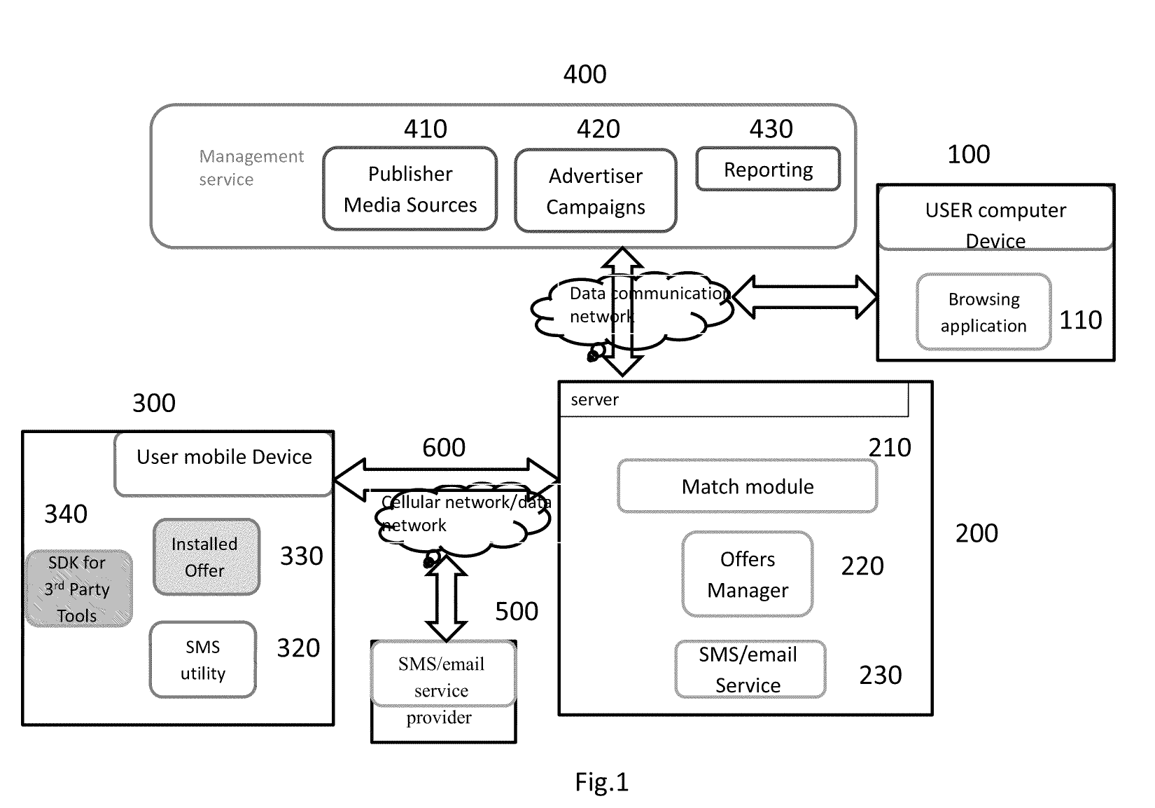

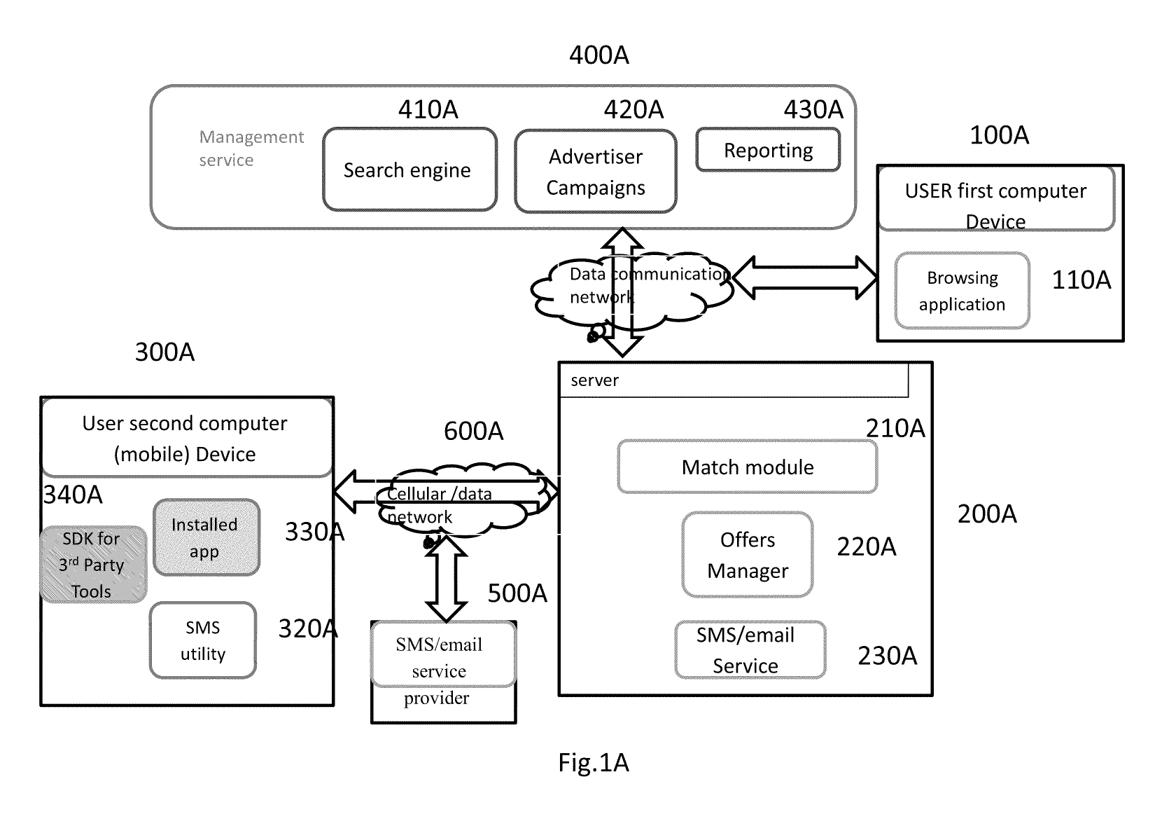

FIG. 1 is a block diagram of a system and environment components which are involved in a digital offer promotion and re-direction process, according to some embodiments of the invention. The user surfs using a first device 100 at publisher media sources 410, which are defined in management service 400 through a data communication network. Management service 400 further includes an advertiser campaign 410 and a reporting utility 430.

The server 200 includes: an offers manger 220 for controlling digital offer redirection and activation, and a matching module 210 for filtering and selecting the digital offers based on user information of surfing context and campaign targeting rules. The server 200 may also include an SMS service 230 for managing the messages transmission using third-party SMS service provider 500.

The user second device 300 includes SMS or email utility 320 for receiving an SMS or email message from the server 200 through cellular or other network 600, enabling the user to activate hyperlink referral to the digital offer landing page using the data network. The Software Development Kit (SDK) 240 that is running on the user device 300, is activated from the installed offer 330 on the mobile device, enabling to send post back to server 200 (feedback message) indicating the user started to use the digital offer with association to the unique ID which identifies the user , the publisher and the selected offer.

FIG. 1A is a block diagram of a system and environment components which are involved in a promotion and a re-direction process of mobile application installation, according to some embodiments of the invention.

The user surfs using a device 100A at search engine 410A, which are connected to a management service 400A through a data communication network. Management service 400A further includes an advertiser campaign 410A and a reporting utility 430A.

The server 200A includes: an offers manger 220A for controlling installation of mobile app redirection and activation, and a matching module 210A for filtering and selecting the mobiles apps based on keywords received for the search engine and campaign targeting rules. The server 200A may also include an SMS service or email 230A for sending SMS messages/email message or alternatively use third party SMS service provider 500A.

The user mobile device 300A includes SMS utility/email 320A for receiving an SMS/email message from the server 200A through cellular network 600A, enabling the user to activate hyperlink referral to the mobile application installation page using the data network. The Software Development Kit (SDK) 240 that is running on the user second device 300A, is activated from the installed app 330A on the mobile device, enabling to send post back to server 200A indicating the user started to use the mobile app and ID of the promoted digital offer, the publisher and the user.

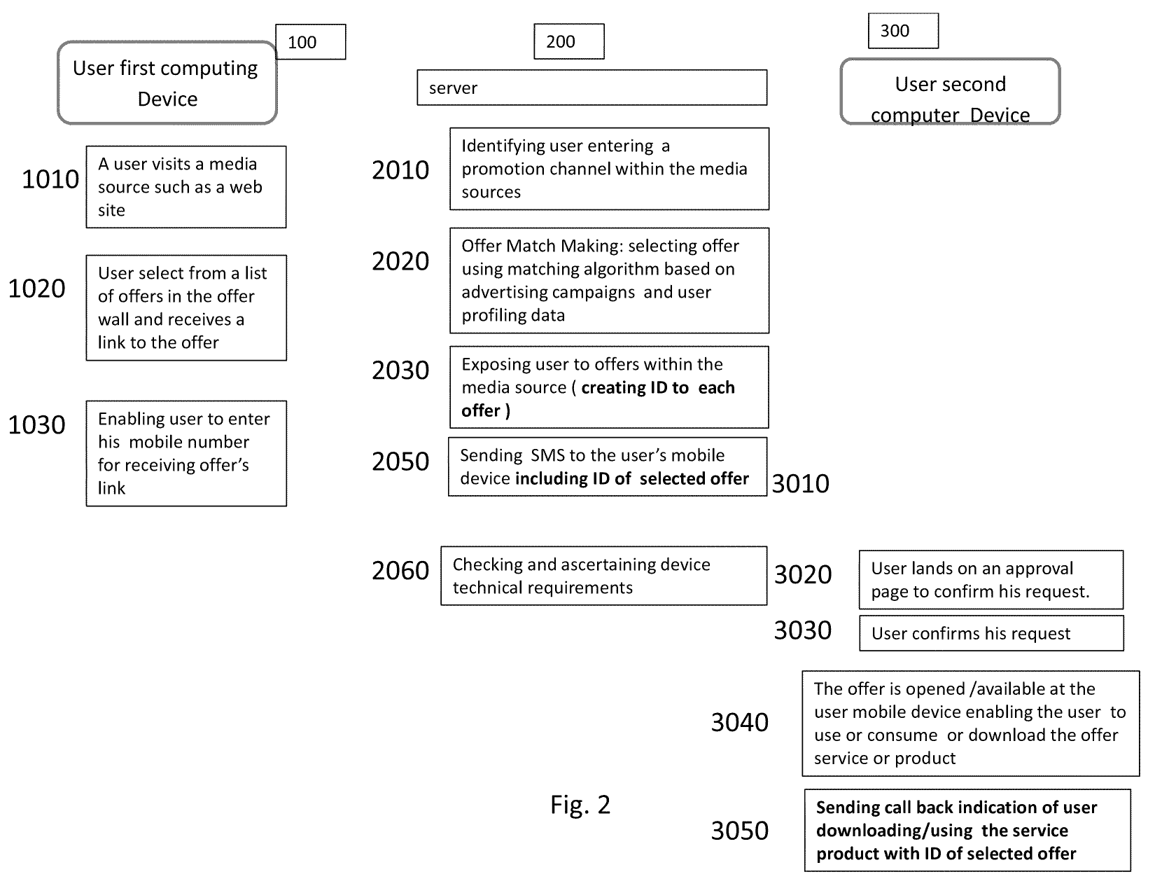

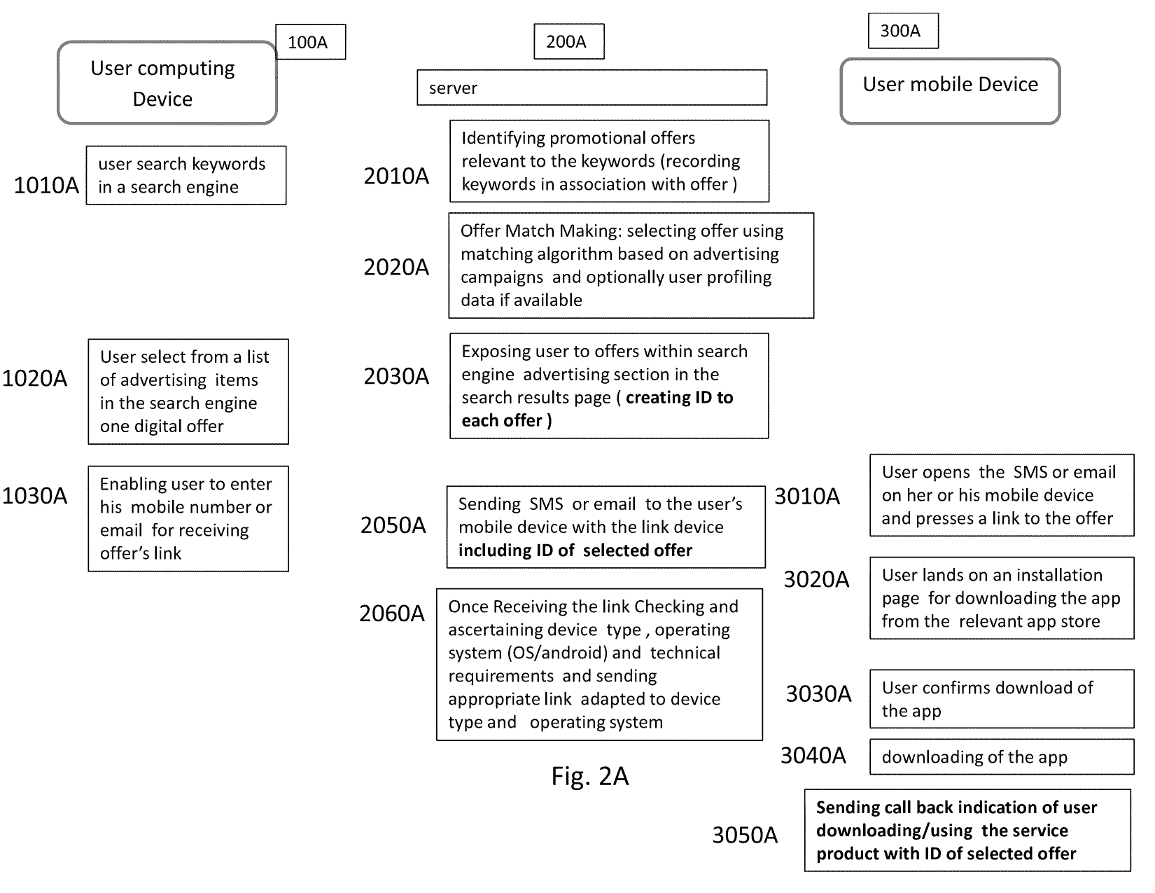

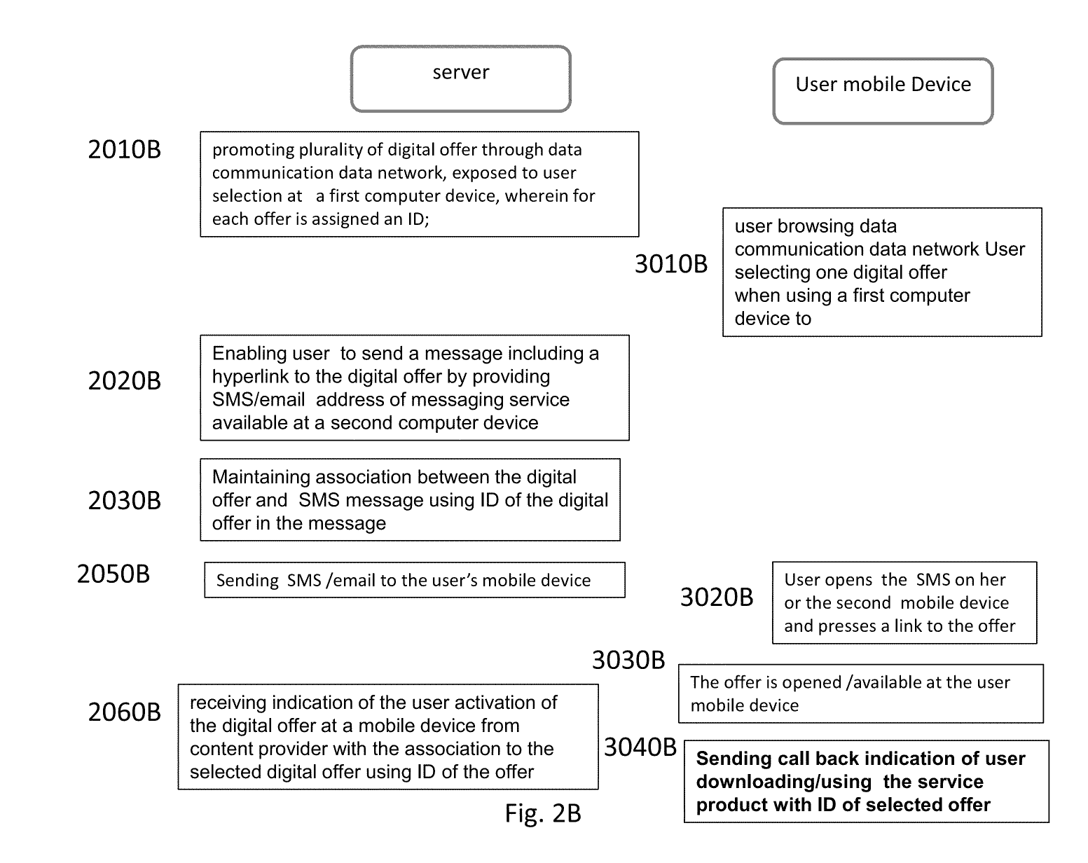

FIG. 2 is a flowchart illustrating a method of promoting and redirecting a digital offer, according to some embodiments of the invention. The process of promoting and redirecting a digital offer starts when a user visits a media source (1010), once identifying the user enters a promotion channel (2010), a matching module 210 is activated for selecting offers to be displayed on an offer wall based on surfing context of the user (i.e. user profiling data) and advertizing campaign targeting rules (2020). The selected offers are presented to the user within the media source (2030). Once the user selects an offer the user can enter her or his mobile phone number or email address for redirecting the digital offer to the user's mobile device (step 1020, 1030).

At the next step the server 200 sends an SMS or email message to the user's mobile device including a link to the digital offer and an ID that uniquely identifies the user and the selected offer data (2050). The user opens the SMS email on her or his mobile device and may press the link to the offer. Before opening the landing page the server ascertains that mobile technical capabilities are adjusted to the requirements of the digital offer (2060). If yes, the user enters the landing page (e.g. App store page), were the user has to confirm the offer request (3030). After the user confirmation the offer is available and the user may consume a content service or download an application (3040). Once the user downloaded or opened the application, a feedback message is sent form the second mobile device to the sever with the unique ID identifying the selected digital offer, the publisher and the user (step 3050).

FIG. 2A is a flowchart illustrating a method of promoting a redirecting installation of mobile application utilizing search engine platform, according to some embodiments of the invention.

The process of promoting and redirecting an installation of mobile app starts when a user surfs a search engine (1010a) entering keywords, promotional offers of mobile app relevant to the keywords are identified (2010), a matching module is activated for selecting offer using matching algorithm based on advertising campaigns and optionally of user profiling data if available (in case user is registered to search engine) (2020a). The user is exposed to offers of mobile apps within search engine advertising section in the search results page (2030a) each offer having an ID. Once the user selects an offer, from the advertising lists, the user can enter her or his mobile phone number or email for redirecting the digital offer to the user's mobile device (step 1020a, 1030a).

At the next step the server 200a sends an SMS message or email to the user's mobile device including a link to the digital offer (2050a) and ID of the promoted offer. The user opens the SMS or email on her or his mobile device and may press the link to the offer. Before opening the app installation page the server ascertains device type, operating system (OS/android) and technical requirements and sending appropriate link adapted to device type and operating system (2060a). This ascertaining process redundant the need of pre knowledge of the mobile device type, which is unknown when the user surf the web. The user enters the apps downloading page, were the user has to confirm the downloading of the application (3030A). After the user confirmation the application is downloaded to his mobile device (3040)A. Once the user downloaded or opened, the application a feedback message is sent from the second mobile device to the sever with the associated ID of the digital offer, the publisher and the user (step 3050).

During this promotion and redirection process, is maintained the association between the mobiles apps and the keyword, providing valuable information for future the app providers' campaigns.

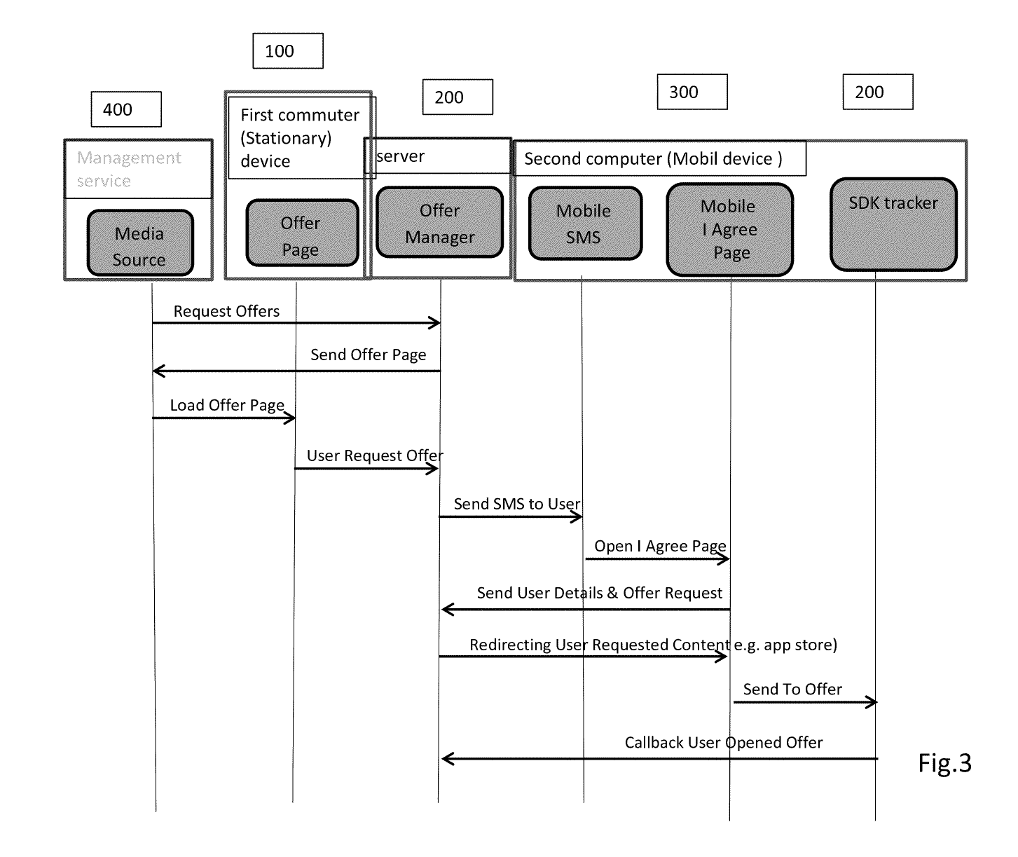

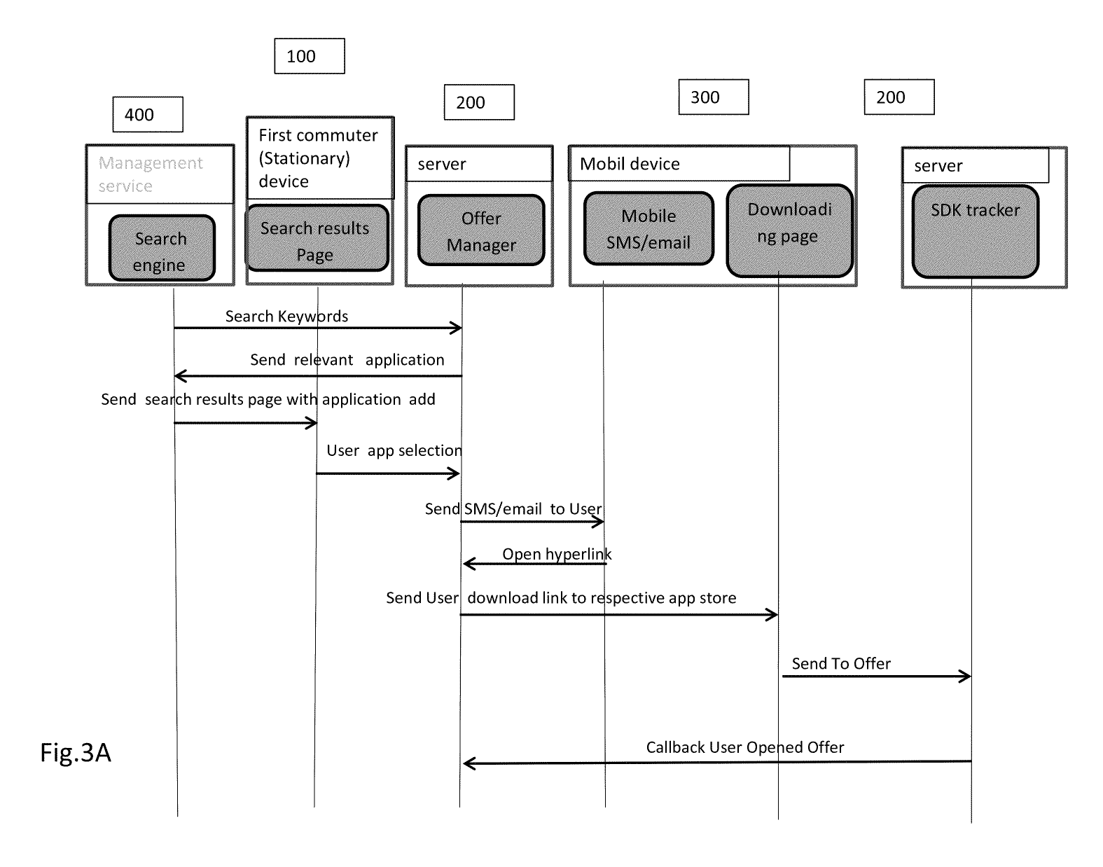

FIG. 3 is a sequence diagram illustrating a technical processing of a digital offer, according to some embodiments of the invention. An offer request is conveyed to offer manager at the server, which in return sends the offer wall page. The offer page is loaded and upon user selection, an offer request is sent to the server with offer ID. Then, the server sends an SMS or email message with a link to the digital over landing page designated to mobile devices with a unique identification of the offer, the publisher and the user. The user opens the offer landing page, for confirming the offer request. The offer manger at the server receives the user details such as the mobile device spec and or user profile and in return sends the content of the offer. The user may activate the offer, after the offer was sent to a tracking SDK. At the end of the process, a callback indicating of user opening the offer is conveyed to the offer manager with the unique identifier (feedback massage).

FIG. 3A is a sequence diagram illustrating a technical processing promoting a redirecting installation of mobile application utilizing search engine platform, according to some embodiments of the invention.

Search key words are conveyed from search engine to the offer manger in the server, which in return sends the relevant apps promotion according to the key words. The search engine creates search results page which includes advertising of relevant app installation promotion. The search results page is presented to the user enabling him to select an app installation promotion having a unique ID. The user is required to enter his mobile phone number or email, the user selection and details are sent to the server. Then, the server sends an SMS or email message with a hyperlink to the digital offer and the unique identifier of the offer and user. The user opens the hyperlink, accordingly the offer manager at the server ascertains user mobile device technical details and in return sends link to the appropriate download page of the mobile application. The user may download the application from the respective app store. At the end of the process, a callback indicating of user downloading the application is conveyed to the offer manager with the unique identifier. This call back information is conveyed to the offer manager providing him with association between the promoted digital offer, the keywords used for promotion and the downloading or usage of the application.

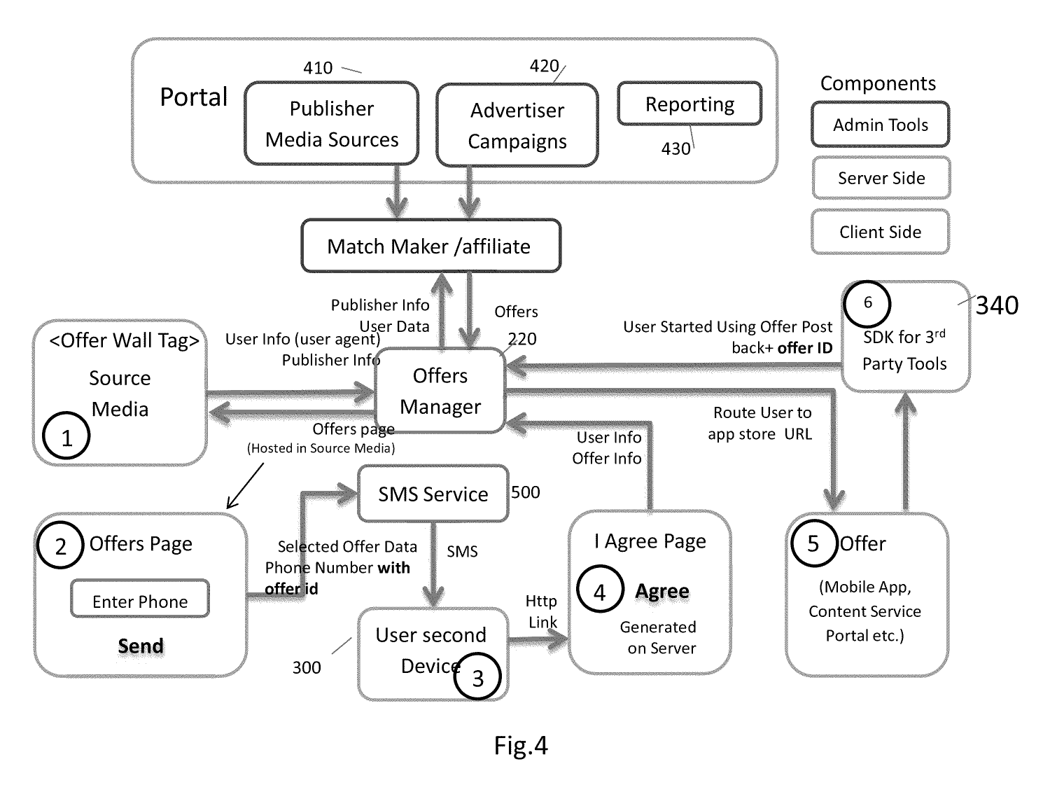

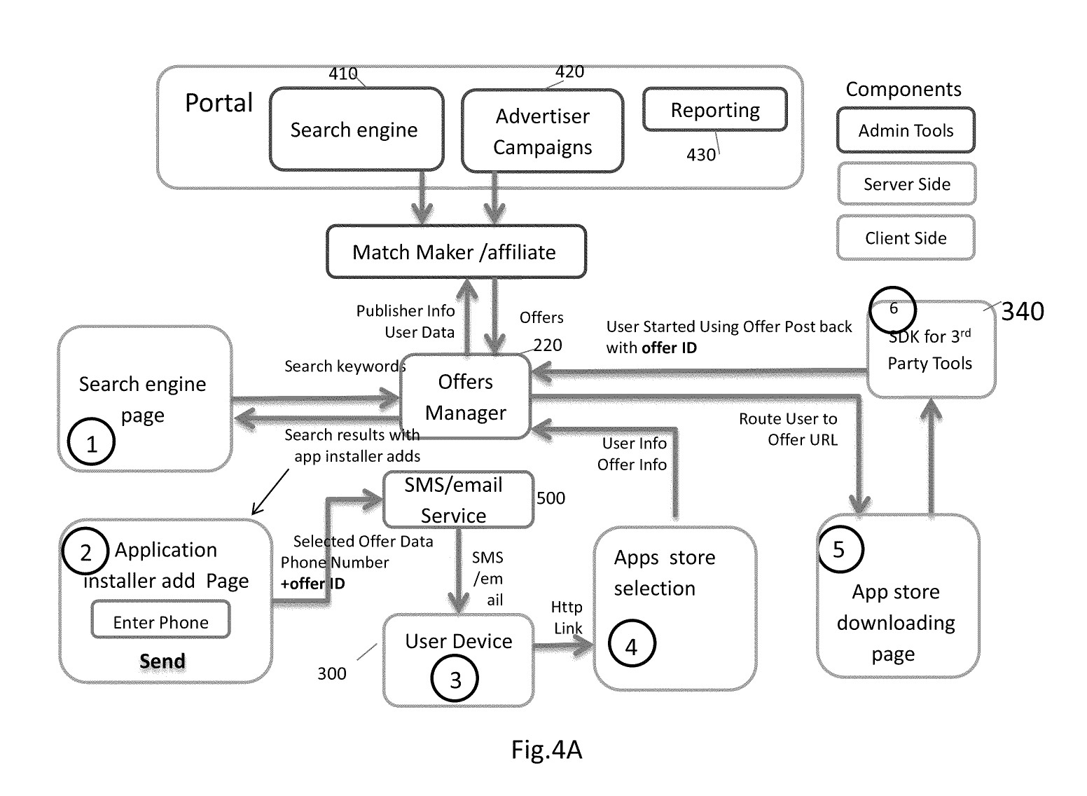

FIG. 4 is illustrating an information flow between the different entities of the system, according to some embodiments of the invention.

The flow starts when the user browse through the publisher source media (1), using a first computer device, viewing available offer page received from the offer manager 220, when selecting an offer the user is requested to enter his phone number or email address (2). Next an SMS message or email is sent to the user second computer device (3) including link to the digital offer and the unique identifier, which is composed of the offer ID and the user. Then the user opens the hyperlink at the I Agree page for example (4) redirected to the relevant downloading page (5). Once the user downloaded or started using the app, the SDK 340 sends a post back to the offer manager 220, with the unique identifier (6). At this stage the offer manger can updated the publisher of downloaded apps, in association to the Promoted digital offer with the relevant used keywords, enabling the publisher to track the success of his campaign in relation to the different promotion strategic.

FIG. 4A is illustrating an information flow between the different entities relating search engine platform, according to some embodiments of the invention.

The flow starts when the user browse through a search (1), using a first computer device, viewing available offer is return to a search query, received from the offer manager 220, when selecting an offer the user is requested to enter his phone number or email address (2). Next an SMS message of email is sent to the user second computer device (3) including link to the digital offer and a unique identifier of user and the offer. Then the user opens the hyperlink at the Apps store for example (4) redirected to the relevant downloading page (5). Once the user downloaded or started using the app, the SDK 340 sends post back to the offer manager 220, with the unique identifier (6). At this stage the offer manger can updated the publisher of downloaded apps, in association to the Promoted digital offer with the relevant used keywords, enabling the published to track the success of his campaign in relation to the different promotion strategic.

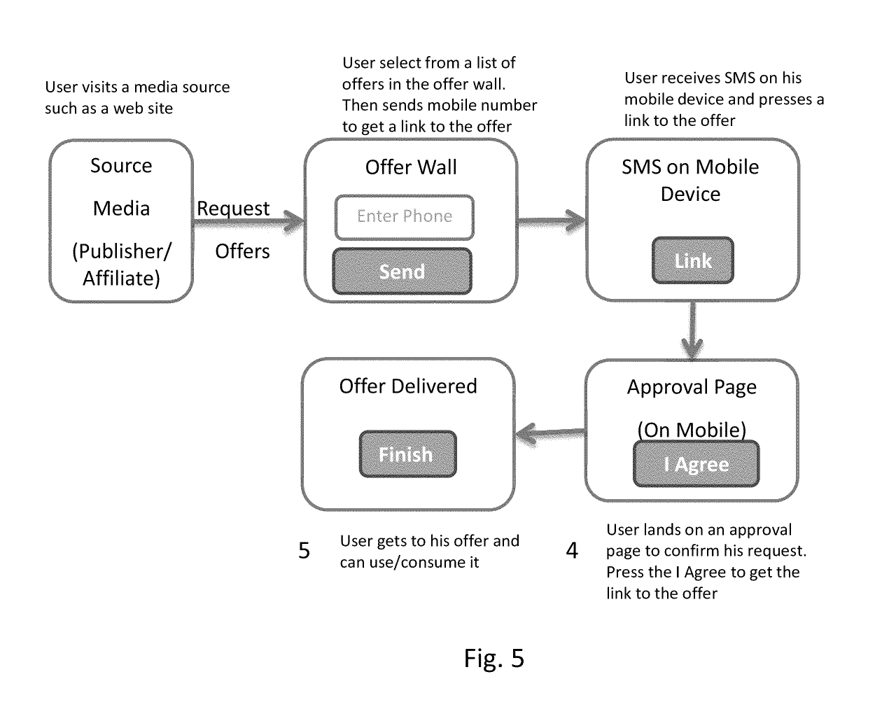

FIG. 5 is illustrates a work flow according to some embodiments of the invention.

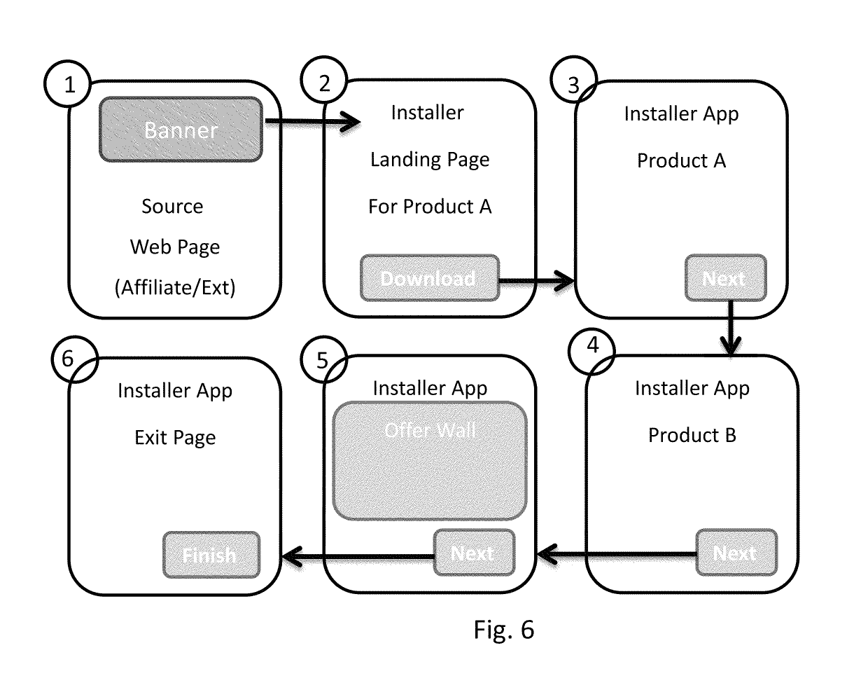

FIG. 6 illustrates a work flow of one scenario of promoting digital offers, according to some embodiments of the invention. According to this scenario the process is started when the user clicks a banner, which redirects the user to an installer landing page of a product A. The user chooses to download and install product A. Within product A installer, the user may install additional products, such as product B. During the installation an offer wall is opened, providing the user the redirection process as described above, by sending an SMS or email message with a link to an offer on the user's mobile device.

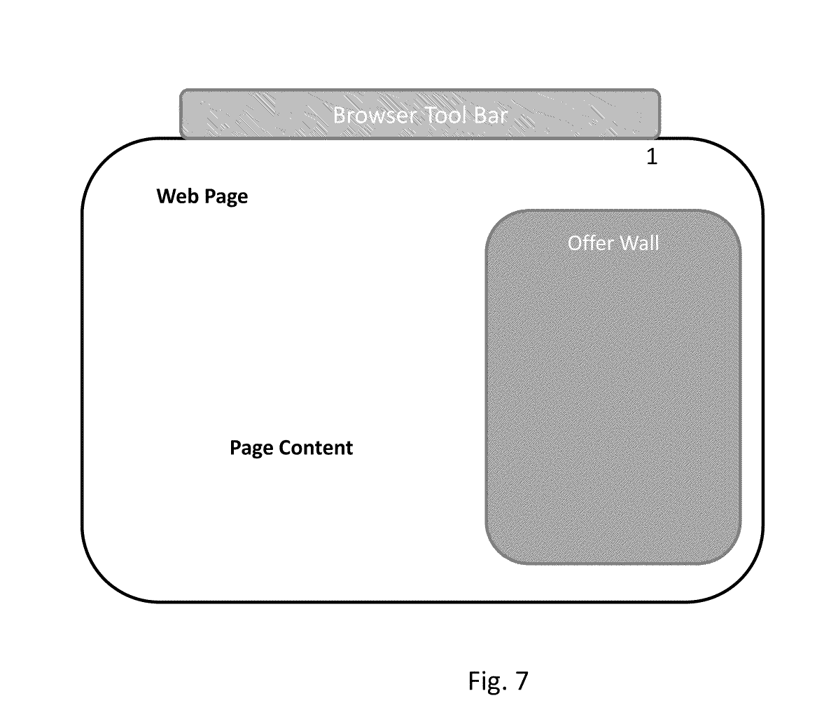

FIG. 7 is illustrates a work flow a method of a second scenario of promoting digital offers, according to some embodiments of the invention. According to the second scenario the process is started when the user surf the web using a browser that includes a widget (such a tool bar) holding an offer wall. The user may activate the widget thus opening the offer wall. Once opening it, the user continues with the offer wall process as described above.

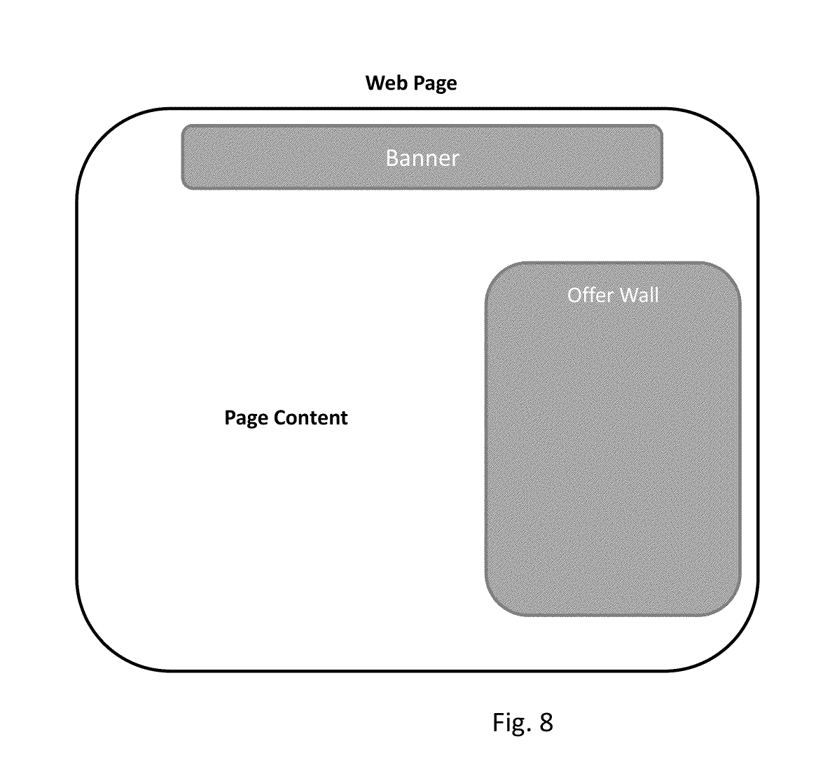

FIG. 8 illustrates a simple presentation of an offer wall within a publisher site while being reviewed through a browser;, according to some embodiments of the invention. According to the third scenario the process is started when the user views a banner that hosts an offer wall. In this use case, a user lands on a content page of an affiliate/publisher, where he can view the offer wall as part of the page content.

The process of selecting which offers to provide to the client is crucial to the success of the product. Therefore, according to some embodiments of the present invention it is suggested that the offers selection process which is performed by match making algorithm will be based on various criteria.

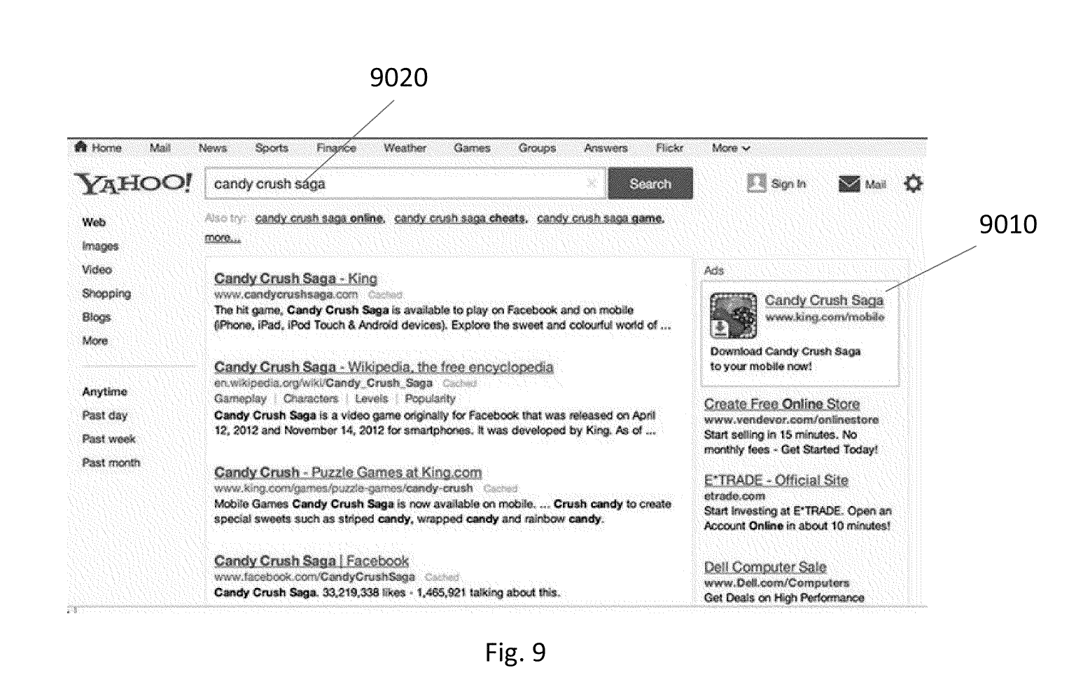

FIG. 9 is a screen shot illustrating the promotion of mobile application in search result web page, according to some embodiments of the invention. As can be seen in the Figure, the user enter keywords “candy crash saga” and is promoted with an ad to install “candy crash saga” application on the mobile device.

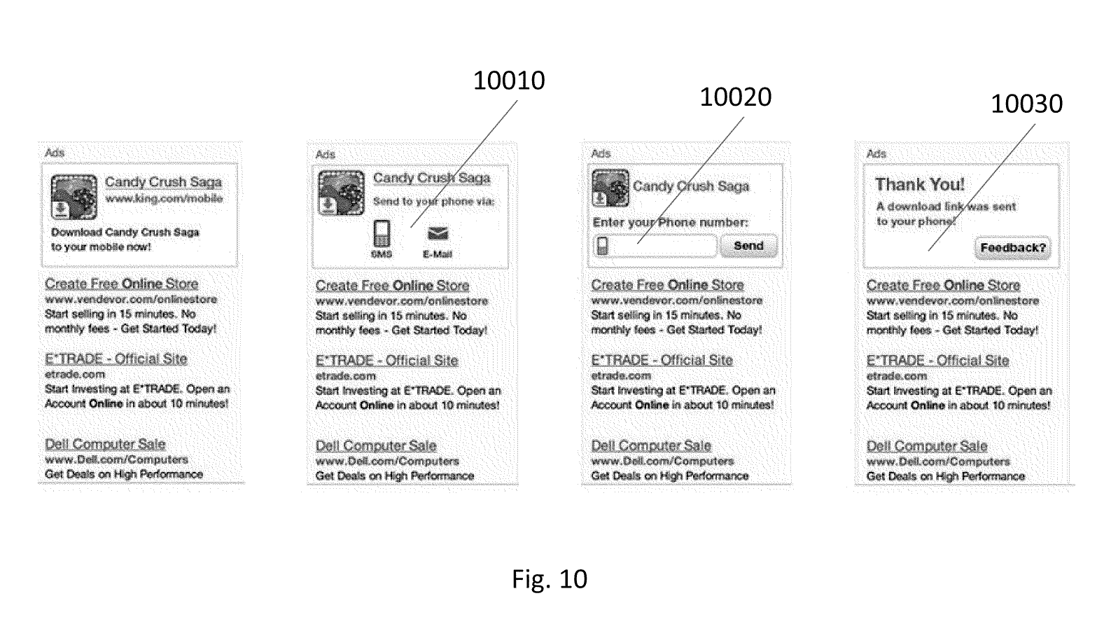

FIG. 10 is a screen shot illustrating the usage of the promotion of mobile application in search result web page, according to some embodiments of the invention. In case the user selected the installation promotion, a widget (10010) is opened with in the advertising section enabling selection between inserting mobile phone number or email. Once the user selected one option the GUI enables to insert mobile phone number or email (10020). At the end of this GUI section the user may send feedback relating this promotion (10).

According to some embodiments of the invention it is suggested to apply: A two phase approach: In each client request, the offer manager run a selection process as follows: first are included only offers that are targeted to the user country and their campaign targeting is not already capped for the selected period of time. Second, each digital offer—offer is ranked according to at least one the following criteria: shared categories of the digital offer with the publisher campaign, the digital offer support the language of the publisher campaign, payout value of the digital offer, matching of app categories with previous user's selections, multiple support of operating platform (e.g. IOS, Android, Windows), App conversion rate (number of installs/number of appearances), new apps in the market. Based on the apps ranking are present to the user the top n apps from the list at the offer wall.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A method for tracking a digital offer which is promoted on a first computer device to be utilized on a second computer device, said method comprising the steps of:
promoting plurality of digital offers through data communication data network, exposed to user selection at a first computer device;
providing a user with an interface for browsing said data communication data network while using a first computer device to select one digital offer and initiate transmission of an offer message including a hyperlink to the digital offer by providing communication address which is available through messaging service on the user second communication device;
associating between the selected digital offer and the transmitted message;
transmitting the offer message with hyperlink of the digital offer to the second computer device, using the user provided communication address;
sending a feedback message indicating of the user activation or consumption of the digital offer at a second device, said message including association to the selected digital offer, wherein said feedback message is initiated by an application program running at the second computer device;
wherein the providing , associating transmitting and receiving are performed by a communication server.

2. The method of claim 1 wherein for each digital offer is assigned an unique ID identifying the digital offer, the publisher and the user, said unique ID is embedded within the offer message transmitted to the second computer device and in the feedback message sent back from the second device.

3. The method of claim 1 wherein the feedback message is reported to the publisher of the digital offer with the association between the activation of digital offer on the second device and promotion of the digital offer in the first computer device.

4. The method of claim 1, wherein the promotion is of the digital offer is placed in a web page as part of a content portal.

5. The method of claim 1, wherein the promotion is of the digital offer is placed as a banner in a web page.

6. The method of claim 1, wherein the promotion is of the digital offer is placed in advertising of a webpage which is a result of a search query performed on the web, wherein the digital offer is associated with key works of the search query and activation of the digital offer in the second computer device.

7. The method of claim 6 wherein the in feedback message is reported to the offer manager with the association between the activation of digital offer on the second device, the digital offer promoted in the first computer device and search words which initiated the promotion of the digital offer.

8. A method for tracking a digital offer which is promoted on a first computer device to be utilized on a second computer device, said method comprising the steps of:
creating a promotional digital offer page within content media source available through a data communication network;
identifying a user surfing through the media source using her or his first computing device and directing her or him to at least one offer page;
enabling the user to insert her or his mobile phone number or email within the offer page using her or the first computing device;
sending an electronic message to the second computer device associated with inserted number, wherein the message includes a hyperlink to activate the digital offer and a unique ID identifying the digital offer and the user;
activating the digital offer once the user opened the SMS or email message on the second device and activated the embedded hyperlink;
sending indication of digital offer activation with the unique ID of the associated digital offer.

9. A system for tracking digital offer which is promoted on a first computer device to be utilized on a second computer device, said system comprised of:
publishing platform for promoting plurality of digital offers through data communication data network, exposed to user selection at a first computer device;
offers Manager server which enables a user browsing said data communication data network to select one digital offer, initiate transmission of an offer message including a hyperlink to the digital offer by providing communication address which is available through messaging service on the user second device, associating between the selected digital offer and the transmitted message and sending from the application running on the second computer device, a feedback message indicating of the user activation of the digital offer with the association to the selected digital offer.

10. The system of claim 9 wherein for each digital offer is assigned an unique ID identifying the digital offer and the user, said unique ID is embedded within the offer message transmitted to the second computer device and in the feedback message sent back from the second device.

11. The system of claim 9 wherein the in feedback message is reported to the publisher of the digital offer with the association between the activation of digital offer on the second device and promotion of the digital offer in the first computer device.

12. The system of claim 1, wherein the promotion is of the digital offer is placed in a web page as part of a content portal.

13. The system of claim 1, wherein the promotion is of the digital offer is placed as a banner in a web page.

14. The system of claim 1, wherein the promotion is of the digital offer is placed in adverting of a webpage which is a result of a search query performed on the web, wherein the digital offer is associated with key works of the search query and activation of the digital offer in the second computer device.

15. The system of claim 14 wherein the in feedback message is reported to the offer manager with the association between the activation of digital offer on the second device, the digital offer promoted in the first computer device and search words which initiated the promotion of the digital offer.
